(19) United States
(12) Patent Application Publication
(10) Pub. No.: US 2017/0278054 A1
(43) Pub. Date: Sep. 28, 2017

(54) Apparatus for Transferring Physical Items

(71) Applicant: Wal-Mart Stores, Inc., Bentonville, AR (US)

(72) Inventors: Donald R. High, Noel, MO (US); Michael D. Atchley, Springdale, AR (US)

(21) Appl. No.: 15/467,415

(22) Filed: Mar. 23, 2017

Related U.S. Application Data
(60) Provisional application No. 62/313,540, filed on Mar. 25, 2016.

(51) Int. Cl. G06Q 10/08

(52) U.S. Cl. CPC G06Q 10/087

(57) ABSTRACT

A plurality of retail shopping facilities include a first retail shopping facility. A central computer system identifies a lack of a sufficient number of a particular item at that first retail shopping facility and identifies a candidate pool of other retail shopping facilities of that plurality of retail shopping facilities that have the particular item. The central computer system then eliminates any of the other retail shopping facility that have a sufficient sales trend for the particular item to warrant that exclusion. These teachings then provide for arranging to transfer the particular item from the filtered candidate pool (i.e., one or more of the retail shopping facilities included within the filtered candidate pool).

### CROSS-REFERENCE TO RELATED APPLICATION

This application claims the benefit of U.S. Provisional Application No. 62/313,540 filed Mar. 25, 2016, which is incorporated herein by reference in its entirety.

### TECHNICAL FIELD

These teachings relate generally to the physical transfer of items from one location to another.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for all retailers (including but not limited to “bricks and mortar” retailers) to focus on improving the overall customer experience and/or convenience.

Product availability comprises one important customer-satisfaction vector. Some customers, for example, eschew an on-line shopping opportunity in favor of a physical retail shopping facility in order to have immediate access to the item or items they desire. As a result such a customer may be more than disappointed upon discovering that the retail shopping facility they visit has no available stock for an item they desire.

### BRIEF DESCRIPTION OF THE DRAWINGS

The above needs are at least partially met through provision of the apparatus for transferring physical items described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings; and

FIG. 3 comprises a top plan schematic view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments presume a plurality of retail shopping facilities that includes a first retail shopping facility. A central computer system identifies a lack of a sufficient number of a particular item at that first retail shopping facility and identifies a candidate pool of other retail shopping facilities of that plurality of retail shopping facilities that have the particular item. The central computer system then eliminates any of the other retail shopping facilities that have a sufficient sales trend for the particular item to warrant that exclusion. These teachings then provide for arranging to transfer the particular item from the filtered candidate pool (i.e., from one or more of the retail shopping facilities included within the filtered candidate pool).

These teachings will accommodate using a set of rules that achieve the aforementioned identification as a function of, for example, image processing, inventory records, associate-based alerts, and/or consumer-based alerts, to note but a few possibilities in these regards.

By one approach the aforementioned set of rules identifies the aforementioned candidate pool of other retail shopping facilities as a function of geographic proximity to the first retail shopping facility. For example, any retail shopping facilities of the plurality of retail shopping facilities that are beyond a particular geographic distance from the first retail shopping facility can be excluded from the pool of candidate retail shopping facilities.

By one approach, the aforementioned set of rules determines the aforementioned sufficient sales trend as a function of the minimum (or actual) rate at which the particular item is selling at a particular one of the retail shopping facility. Using this approach a retail shopping facility that is only selling the particular item at a slow rate is not excluded from the candidate pool on this basis while another retail shopping facility that is selling the particular item at a brisk rate may be excluded from the candidate pool on this basis. So configured, stores that are selling their inventory of a particular item quickly can be excluded to thereby help to avoid causing such stores to themselves run short on such an item.

These teachings are highly flexible in these regards and will accommodate a variety of approaches and modifications with respect to the aforementioned set of rules. For example, by one approach the rules-specified sales trend used for these purposes may comprise a predicted sales trend rather than an actual measured sales trend. Predicted sales trends may be based, for example, upon seasonally-based statistics.

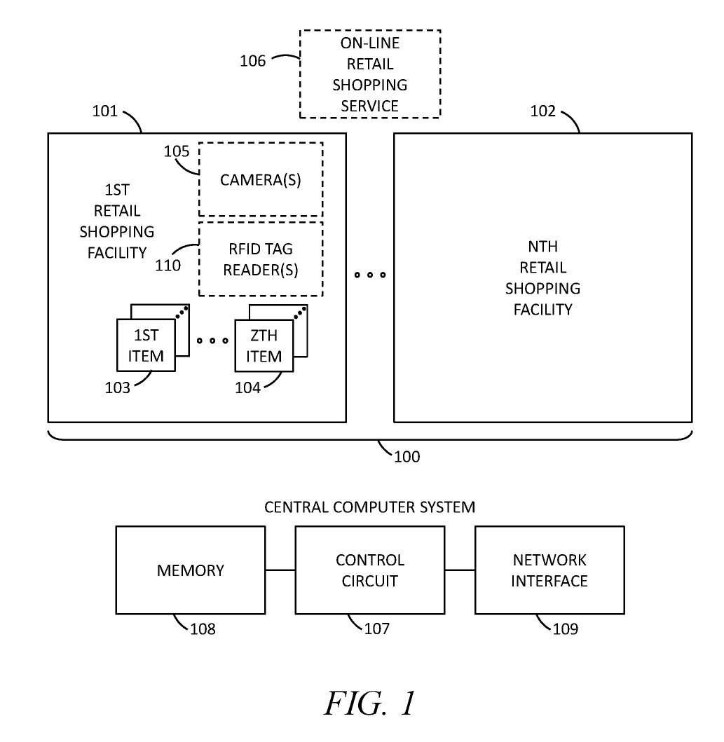

These and other benefits may become clearer upon making a thorough review and study of the following detailed description. Referring now to the drawings, and in particular to FIG. 1, an illustrative enabling apparatus that is compatible with many of these teachings will now be presented.

In this illustrative example the apparatus includes a plurality 100 of retail shopping facilities. These retail shopping facilities are represented here by a first retail shopping facility 101 through an Nth retail shopping facility 102 (where N is an integer greater than 1). Each retail shopping facility comprises a physical retail sales facility or any other type of bricks-and-mortar (i.e., physical) facility in which products are physically displayed and offered for retail sale to customers who physically visit the facility. These products are represented here by a first item 103 through a Zth item 104 (where Z is an integer greater than 1).

It will be understood that a retail shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

By one approach one or more of the retail shopping facilities optionally include one or more (still or video) cameras 105. Captured imagery from such a camera 105 can be utilized as described further herein. By one approach these cameras 105 comprise existing surveillance equipment employed at the retail shopping facility to serve, for example, various security purposes. By another approach these cameras 105 are dedicated to providing content for the express purposes described herein.

If desired, the cameras 105 can have a selectively movable field of view and/or zoom capability that can be non-automatically or automatically controlled as appropriate to help ensure receipt of useful information at any given moment. By one approach, for example, a movable camera can be moved at a time of need (for example, when information regarding current stock at a particular retail shopping facility is needed as per these teachings) to aim particularly at a display and/or backroom storage area where a particular product is expected to be found in order to count (automatically, using image processing methodologies that are known in the art) the quantity of a particular product that is available at this particular facility.

In lieu of the foregoing or in combination therewith, the retail shopping facility may have one or more radio-frequency identification (RFID) tag readers 110 disposed within the facility to read RFID tags on corresponding products. (RFID tags in general and RFID tag readers are both well understood in the art and require no further elaboration here.) So configured, this reader(s) can read the RFID tags that correspond, for example, to a given Stock Keeping Unit (SKU) number to thereby read all of the RFID tags for the particular product that corresponds to that SKU number. By then automatically counting the number of read RFID tags that correspond to a given SKU number the corresponding system can know how many of that corresponding product is presently at the facility.

By one approach, such reading/counting occurs on some periodic basis (for example, nightly and weekly). In that case the count may be off due to intervening sales of the counted product(s). By another approach, in lieu of the foregoing or in combination therewith, such a read/count can occur on an as-needed basis per these teachings. In that case, a read/count can be conducted for a particular product at the time of needing to know, per these teachings, how many of a particular product are available at a particular facility.

In this illustrative example the apparatus also includes a central computer system. This central computer system may be physically located partially or wholly at one of the retail shopping facilities or may be physically located only remotely therefrom as desired. For the sake of an illustrative example it will be presumed here that the central computer system includes a control circuit 107 of choice that carries out the actions, steps, and/or functions described herein.

Being a “circuit,” the control circuit 107 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 107 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 107 is configured (for example, by using corresponding programming as will be well understood by those skilled in the art) to carry out one or more of the steps, actions, and/or functions described herein including specifically the disclosed set of rules.

In this example the control circuit 107 operably couples to a memory 108. This memory 108 may be integral to the control circuit 107 or can be physically discrete (in whole or in part) from the control circuit 107 as desired. This memory 108 can also be local with respect to the control circuit 107 (where, for example, both share a common circuit board, chassis, power supply, and/or housing) or can be partially or wholly remote with respect to the control circuit 107 (where, for example, the memory 108 is physically located in another facility, metropolitan area, or even country as compared to the control circuit 107).

In addition to the information and the set of rules described herein, this memory 108 can serve, for example, to non-transitorily store the computer instructions that, when executed by the control circuit 107, cause the control circuit 107 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 107 also operably couples to a network interface 109. So configured the control circuit 107 can communicate with other elements (both within the apparatus and external thereto) via the network interface 109. Examples of such elements include but are not limited to the aforementioned camera(s) 105 and RFID tag reader(s) 110. Network interfaces, including both wireless and non-wireless platforms, are well understood in the art and require no particular elaboration here.

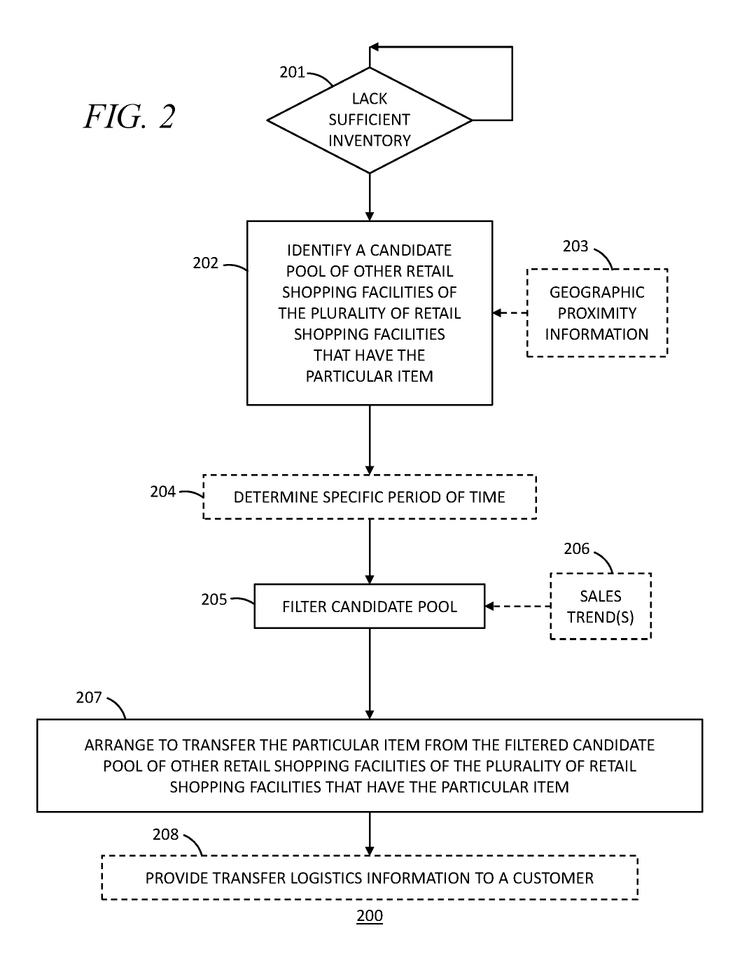

FIG. 2 presents a process 200 that can be carried out by the aforementioned apparatus. By one approach, the aforementioned central computer system (and in particular the control circuit 107) can carry out one or more of the following described steps, actions, and/or functions and in particular can obtain and utilize the below-described set of rules to effect the foregoing.

By one approach, the control circuit 107 obtains (for example, from the aforementioned memory 108) a set of rules as suggested above. These rules serve to make the following determinations as a function of the below-described criteria/events/decisions.

At decision block 201, the control circuit 107 determines when a lack of a sufficient number of a particular item occurs at the first retail shopping facility 101 and hence identifies that circumstance. The control circuit 201 can base this determination/identification upon rules that make use of any of a variety of inputs, data, and/or criteria. By one approach the control circuit 107 uses the rules to determine whether the supply of this particular item is exhausted. By another approach the control circuit 107 uses the rules to determine whether the supply of this particular item has dropped to less than some predetermined level, such as less than two items, five items, ten items, or whatever other level may be appropriate to suit the needs of a given application setting.

As one example in these regards, the rules provide for making this determination using image processing. In particular, still and/or video images provided by one or more of the aforementioned cameras 105 at the first retail shopping facility 101 can be processed to identify the presence of the aforementioned particular item and, more particularly, how many of this item are available at this first retail shopping facility 101. This determination can include a count, for example, of all of the particular items that are available in a retail display area of the first retail shopping facility 101 as well as how many of this particular item are located in a non-public storage area of the first retail shopping facility 100. (Image processing comprises a well-understood prior art endeavor. As the present teachings are not overly sensitive to any particular choices made in these regards, further elaboration regarding image processing is not provided here for the sake of brevity.)

As another example in these regards, the control circuit 107 makes this determination using inventory records that pertain to the first retail shopping facility 101. These inventory records may be available, for example, at the aforementioned memory 108. These inventory records may include data gleaned from associate-conducted activity (such as manually-conducted inventory assessments) and any of a variety of automated activities (such as inventory assessments facilitated by RFID tag scanning, Point Of Sale (POS) optical scans, and so forth). By one approach the utilized inventory records specify the number of items at the first retail shopping facility 101. By another approach, if desired, the foregoing information can be supplemented with inventory information regarding items that are scheduled to arrive at the first retail shopping facility 101 within a predetermined window of time (such as one hour, four hours, eight hours, 12 hours, one day, or some other duration of choice).

As another example in these regards, the control circuit 107 makes this determination using rules that themselves make use of associate-based alerts. For example, an associate working at the first retail shopping facility 101 may utilize a manual or automated process to specifically permit the associate to indicate when a particular item is out or running low in quantity.

And as yet another example in these regards, the control circuit 107 makes this determination using consumer-based alerts. For example, a consumer at the first retail shopping facility 101 may notify the enterprise, via a facility associate or an automated mechanism, that an adequate supply of the particular item is not presently available.

The present teachings are highly flexible in practice. By one approach, the control circuit 107 monitors inventory levels and makes the above-described determination on a continuous basis. Such an approach can be useful when the goal is to identify when any items are lacking in advance of any customer making a specific request for the particular item. By another approach, in lieu of the foregoing or in combination therewith, the control circuit 107 makes this determination on an item-by-item basis in response to processing a customer's specific request for a particular item.

Upon identifying a lack of a sufficient number of a particular item at the first retail shopping facility 101, at block 102 the control circuit 107 uses the rules to identify a candidate pool of other retail shopping facilities of the plurality of retail shopping facilities 100 that have the particular item. By one optional approach the rules provide for identifying this candidate pool using geographic proximity information 203. In particular, the rules formulate the candidate pool as a function of geographic proximity to the first retail shopping facility 101.

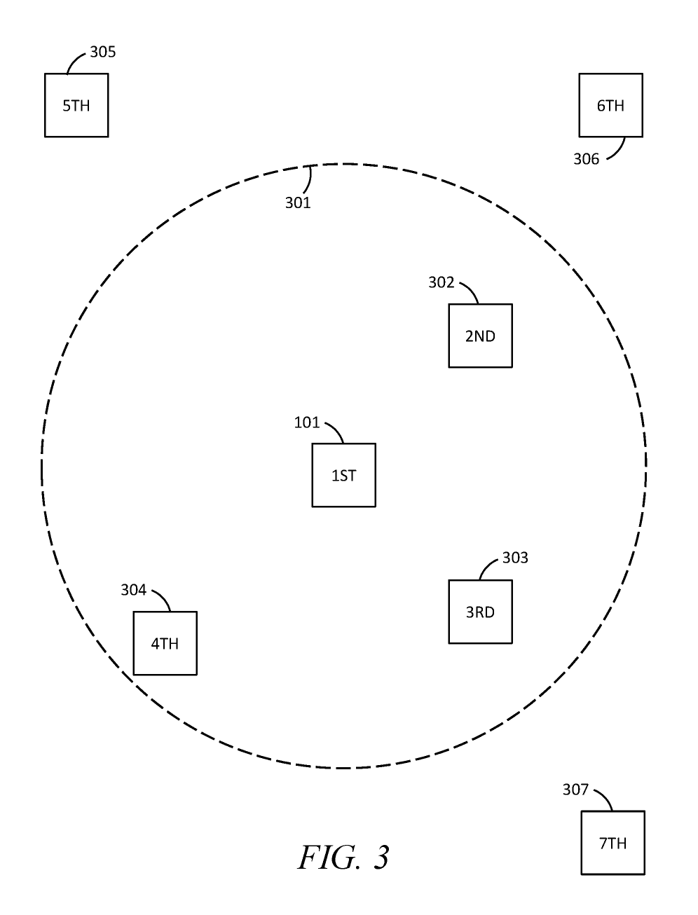

FIG. 3 provides a simple illustrative example in these regards. In this example, the control circuit 107 identifies the retail shopping facilities that have the predetermined item on hand and that are also within a predetermined distance (represented by the circle denoted by reference numeral 301) of the first retail shopping facility 101. In this example there are three such retail shopping facilities 302, 303, and 304. Other retail shopping facilities 305, 306, and 307 are beyond the predetermined distance 301 and accordingly are not included in the candidate pool of other retail shopping facilities that have the particular item.

By one approach the rules for the aforementioned predetermined distance 301 can represent a static parameter that does not change. By another approach the rules can permit or otherwise utilize a more dynamic parameter if desired. For example, different predetermined distances 301 may be used for different items or different general categories of items. As one simple illustrative example in these regards, items that have a retail price below a certain predetermined level (such as one dollar or ten dollars) can use a first predetermined distance (such as five miles) that is less than the predetermined level (such as ten miles) that is used for items having a higher retail price. By another approach, in lieu of the foregoing or in combination therewith, a different predetermined distance 301 may be used at different times of the year.

Those skilled in the art will recognize that the foregoing considerations are collectively and individually likely different in both kind and degree from the kinds of considerations that practitioners have in the past possibly utilized to locate needed inventory at a different sister retail facility. Nevertheless, the applicants have determined that populating a pool of candidate facilities in the foregoing regards can be particularly beneficial at least in part because subsequent filtering is also contemplated by these teachings. In particular, this further filtering can reduce the number of candidate retail shopping facilities in the candidate pool. Per these teachings the aforementioned rules conduct that filtering as a function of sales trend information.

By one approach this sales trend information represents a rate at which the particular item is selling over a particular specific period of time (for example, a particular number of days that immediately precede when the control circuit 107 might arrange to transfer the particular item from one of the retail shopping facilities in the candidate pool). If desired that specific period of time can comprise a static parameter.

If desired, however, at optional block 204 the control circuit 107 can dynamically determine a particular specific period of time. This dynamically-determined particular specific period of time can then be used when calculating a rate at which the particular item is selling (i.e., the rate at which the particular item is selling is determined over that particular specific period of time). As one illustrative example in these regards, one period of time (such as 1 to 3 days) can be employed when considering a product with a short shelf life while another period of time (such as one week or one month) might be employed when considering a product with a longer shelf life.

At block 205 the rules provide for filtering the aforementioned candidate pool by eliminating from the candidate pool any of the retail shopping facilities that have at least a sufficient sales trend 206 for the particular item; i.e., that are selling the particular item at a sufficiently high rate. So configured, a retail shopping facility that is only selling the particular item at a slow rate is not excluded from the candidate pool of retail shopping facilities that have the particular item.

This level of “sufficiency” can comprise a static value that applies across all product lines and at any time. If desired, however, the requisite level of sufficiency can vary by product line as desired such that different products may have a different corresponding level of sufficiency to be applied in these regards. In such a case, the rules can provide for selecting a level of sufficiency to apply in these regards as a function of the product at issue. In lieu of the foregoing the requisite level of sufficiency may vary with the season, such that the rules will provide for selecting a level of sufficiency as a function of the time of year. Other possibilities are available, such as selecting the requisite level of sufficiency as a function of one or more of a time of day, a day of the week, product size and/or weight, product maintenance requirements (such as refrigeration), product cost at wholesale or retail, product branding, the presence or absence of applicable regional promotions (immediately past, present, or near-term future), and so forth, to note but a few examples.

By one approach, this sales trend information 206 comprises a to-date aggregated rate. By another approach, this sales trend information 206 comprises a rate at which the particular item in selling over a particular specific period of time (such as the aforementioned specific period of time as determined by the control circuit 107).

By one approach and as inherently suggested above this sales trend information 206 comprises an actual historical sales rate. By another approach, in lieu of the foregoing or in combination therewith, the control circuit 107 utilizes as a filtering criteria a sufficient sales trend that represents a predicted minimum rate at which the particular item will likely be selling at a particular one of the retail shopping facilities. As one example in these regards, that predicted minimum rate can be based, at least in part, upon seasonally-based statistics (such as, for example, a statistically-based average, mean, or peak calculated value). Using this approach, relatively small and/or steady sales rates for particular items can be modified to reflect anticipated seasonal increases in those rates of sales.

Referring again momentarily to the example presented in FIG. 3, three retail shopping facilities 302, 303, and 304 were within the predetermined distance 301 and hence qualified for initial inclusion in a pool of candidate retail shopping facilities. When the sales trend information 206 indicates, however, that the retail shopping facility denoted by reference numeral 303 is selling the particular item at a rate beyond the aforementioned sufficient sales trend, that retail shopping facility 303 is removed from the pool of candidates. Accordingly, in this example, by application of the requisite rules the resultant filtered pool of candidates includes only two retail shopping facilities 302 and 304.

Having now identified those nearby stores from which the particular item can likely be safely transferred without causing corresponding customer inconvenience at the transferring store, and referring again to FIGS. 1 and 2, at block 207 the control circuit 107 arranges to transfer the particular item from one or more retail shopping facilities of the filtered candidate pool. By one approach this comprises transferring the particular item (in a particular quantity as may also be specified by the control circuit 107) to the first retail shopping facility 101. By another approach, this comprises transferring the particular item directly to an off-site customer (for example, to their residential address or place of business). These teachings will accommodate allowing the customer to select from these and other delivery options as desired.

At optional block 208 the control circuit 107 can provide corresponding transfer logistics information to the customer regarding the particular item. Examples in these regards include an estimated time of delivery and/or an alert when delivery of the particular item is complete. These teachings will accommodate any of a variety of communications modalities. Examples include but are not limited to email notifications, text messages notifications, smart phone and/or tablet/pad-style device app alerts, and so forth as desired.

So configured, these teachings employ automatically-applied filter-based rules to permit a bricks and mortar-based enterprise to more expediently meet immediate and/or anticipated customer requirements at one physical location without potentially creating a future deficiency at another physical location. Accordingly, these teachings help ensure greater efficiency and improved customer satisfaction.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a plurality of retail shopping facilities that includes a first retail shopping facility;
a central computer system configured to:
obtaining a set of rules that identify at least one retail shopping facility from amongst a plurality of retail shopping facility as a function of multiple criteria and filtering;
identify a lack of a sufficient number of a particular item at the first retail shopping facility;
identify a candidate pool of other retail shopping facilities of the plurality of retail shopping facilities that have the particular item via application of the set of rules;
eliminate from the candidate pool any of the other retail shopping facilities that have a sufficient sales trend for the particular item to provide a filtered candidate pool of other retail shopping facilities of the plurality of retail shopping facilities that have the particular item via application of the set of rules;
arrange to transfer the particular item from the filtered candidate pool of other retail shopping facilities of the plurality of retail shopping facilities that have the particular item.

2. The apparatus of claim 1 wherein the central computer system is configured to identify the lack of a sufficient number of the particular item at the first retail shopping facility using at least one of:
image processing;
inventory records;
associate-based alerts;
consumer-based alerts.

3. The apparatus of claim 1 wherein the central computer system is configured to identify the lack of a sufficient number of the particular item at the first retail shopping facility in response to processing a consumer's request for the particular item.

4. The apparatus of claim 1 wherein the central computer system is configured to identify the lack of a sufficient number of the particular item at the first retail shopping facility in advance of any customer making a specific request for the particular item.

5. The apparatus of claim 1 wherein the central computer system is configured to identify the candidate pool of other retail shopping facilities of the plurality of retail shopping facilities that have the particular item, at least in part, as a function of geographic proximity to the first retail shopping facility.

6. The apparatus of claim 5 wherein the central computer is configured to identify the candidate pool of other retail shopping facilities of the plurality of retail shopping facilities that have the particular item, at least in part, as a function of geographic proximity to the first retail shopping facility by excluding any of the other retail shopping facilities that are beyond a particular geographic distance from the first retail shopping facility.

7. The apparatus of claim 5 wherein the central computer is configured to identify the candidate pool of other retail shopping facilities of the plurality of retail shopping facilities that have the particular item, at least in part, as a function of geographic proximity to the first retail shopping facility by including only the other retail shopping facilities that are closest to the first retail shopping facility up to a predetermined number of such retail shopping facilities.

8. The apparatus of claim 1 wherein the sufficient sales trend represents a minimum rate at which the particular item is selling at a particular one of the retail shopping facilities, such that a retail shopping facility that is only selling the particular item at a slow rate is not excluded from the candidate pool of other retail shopping facilities of the plurality of retail shopping facilities that have the particular item on the basis of the sales trend.

9. The apparatus of claim 8 wherein the rate at which the particular item is selling comprises a rate at which the particular item is selling over a particular specific period of time.

10. The apparatus of claim 9 wherein the central computer system is configured to dynamically determine the particular specific period of time at the time of needing the particular specific period of time in order to calculate the rate in order to eliminate from the candidate pool any of the other retail shopping facilities that have a sufficient sales trend for the particular item.

11. The apparatus of claim 9 wherein the particular specific period of time comprises a static parameter.

12. The apparatus of claim 12 wherein the particular specific period of time comprises a particular number of days that immediately precede when the central computer system arranges to transfer the particular item from the filtered candidate pool of other retail shopping facilities of the plurality of retail shopping facilities that have the particular item.

13. The apparatus of claim 1 wherein the sufficient sales trend represents a predicted minimum rate at which the particular item will likely be selling at a particular one of the retail shopping facilities, such that a retail shopping facility that is only likely selling the particular item at a slow rate is not excluded from the candidate pool of other retail shopping facilities of the plurality of retail shopping facilities that have the particular item on the basis of the sales trend.

14. The apparatus of claim 13 wherein the predicted minimum rate is based, at least in part, upon seasonally-based statistics.

15. The apparatus of claim 1 wherein the central computer system arranges to transfer the particular item from the filtered candidate pool of other retail shopping facilities of the plurality of retail shopping facilities that have the particular item by arranging to transfer the particular item to the first retail shopping facility.

16. The apparatus of claim 1 wherein the central computer system arranges to transfer the particular item from the filtered candidate pool of other retail shopping facilities of the plurality of retail shopping facilities that have the particular item by arranging to transfer the particular item directly to an off-site customer.

17. The apparatus of claim 1 wherein the central computer system arranges to transfer the particular item from the filtered candidate pool of other retail shopping facilities of the plurality of retail shopping facilities that have the particular item by providing transfer logistics information to a customer regarding the particular item.

18. The apparatus of claim 17 wherein the transfer logistics information includes an estimated time of delivery.

19. The apparatus of claim 17 wherein the transfer logistics information includes an alert when delivery of the particular item is completed.
